(19) United States
(12) Patent Application Publication
(10) Pub. No.: US 2021/0307035 A1
(43) Pub. Date: Sep. 30, 2021

(54) Transmission Scheduling in an Unlicensed Frequency Band

(71) Applicant: Telefonaktiebolaget LM Ericsson (publ), Stockholm (SE)

(72) Inventors: Tai Do, Lund (SE); Thomas Nilsson, Malmö (SE); Peter Alriksson, Hörby (SE)

(21) Appl. No.: 17/056,897

(22) PCT Filed: May 28, 2019
(86) PCT No.: PCT/EP2019/063832

§ 371 Date: Nov. 19, 2020

Related U.S. Application Data
(60) Provisional application No. 62/680,006, filed on Jun. 4, 2018.

(51) Int. Cl. H04W 72/12; H04W 72/14; H04W 74/08

(52) U.S. Cl. CPC H04W 72/1268; H04W 74/0816; H04W 72/14

(57) ABSTRACT

A radio network node (12) is configured for use in a wireless communication system (10). The radio network node (12) is configured to monitor for signaling (20), from each of multiple wireless devices (14) that are candidates for performing uplink transmission within an unlicensed frequency band (18), indicating whether the unlicensed frequency band (18) is deemed clear for the wireless device to transmit within according to a measurement performed by the wireless device over that unlicensed frequency band (18). The radio network node (12) is also configured to schedule, based on that monitoring, uplink transmission within the unlicensed frequency band (18) to be performed by one or more of the wireless devices that each signal the unlicensed frequency band (18) is deemed clear for the wireless device to transmit within.

### TECHNICAL FIELD

The present application relates generally to transmission scheduling in a wireless communication system, and more particularly relates to scheduling uplink transmission in an unlicensed frequency band of the wireless communication system.

### BACKGROUND

Licensed frequency spectrum grows scarcer as the demand for high-speed voice and data communication grows. One approach to combatting licensed spectrum scarcity supplants or supplements use of the licensed spectrum with use of unlicensed spectrum. Licensed Assisted Access (LAA), for example, leverages unlicensed spectrum in combination with licensed spectrum to deliver a performance boost for Long Term Evolution (LTE) user data. In LAA, a base station activates a primary cell operating in licensed spectrum for control signalling transmission and may also activate a secondary cell operating in unlicensed spectrum for user data transmission. MulteFire by contrast may operate entirely in unlicensed spectrum, without relying on licensed spectrum as an anchoring service. These and other technologies enable operators and vendors to meet the growing demand for services even in the face of licensed spectrum scarcity.

Fully exploiting unlicensed spectrum proves challenging, though, in part because most transmissions in unlicensed spectrum can only be performed after sensing the transmission medium is clear, e.g., via a clear channel assessment (CCA) or listen before talk (LBT) procedure. This complicates transmission scheduling especially in the uplink, jeopardizes efficient use of the unlicensed spectrum, and threatens to limit the achievable system performance (e.g., in terms of transmission data rate).

### SUMMARY

According to some embodiments herein, wireless devices each signal whether they detect an unlicensed frequency band as clear for them to transmit within, e.g., by signaling the outcome of their respective CCA or LBT procedures. A radio network node leverages that signaling to schedule uplink transmission within the unlicensed frequency band.

For example, the radio network node in some embodiments effectively schedules uplink transmission to be performed by only the wireless devices that signal they detect the unlicensed frequency band as clear. The radio network node may for instance wait to schedule uplink transmission until after receipt of the signaling from wireless devices. Alternatively, the radio network node may initially schedule uplink transmission without regard to such signaling, but then re-schedule as needed to account for the signaling once it is received. In this case, the “first-pass” initial scheduling may allocate different portions (e.g., interlaces) of the unlicensed frequency band to different wireless devices, but after the signaling is received the “second-pass” re-scheduling may re-allocate the portions given to wireless devices that do not end up signaling the unlicensed frequency band as clear. Indeed, those portions may be re-allocated to the wireless devices that did signal the unlicensed frequency band as clear.

These and other embodiments may accordingly reduce the risk that portions of the unlicensed frequency band go unused because they are allocated to wireless devices that end up not being able to transmit within the unlicensed frequency band. This means that some embodiments herein may efficiently utilize all portions of the unlicensed frequency band for uplink transmission, at least those that are “uplink” portions allocated for uplink transmission. Moreover, by allowing wireless devices which signal the unlicensed frequency band as clear to use portions of the unlicensed frequency band that could not be used by wireless devices which do not signal the unlicensed frequency band as clear, some embodiments increase the achievable system performance (e.g., in terms of transmission data rate and/or robustness to channel conditions).

More particularly, embodiments herein include a method performed by a radio network node configured for use in a wireless communication system. The method comprises monitoring for signaling, from each of multiple wireless devices that are candidates for performing uplink transmission within an unlicensed frequency band, indicating whether the unlicensed frequency band is deemed clear for the wireless device to transmit within according to a measurement performed by the wireless device over that unlicensed frequency band. The method also comprises scheduling, based on said monitoring, uplink transmission within the unlicensed frequency band to be performed by one or more of the wireless devices that each signal the unlicensed frequency band is deemed clear for the wireless device to transmit within.

In some embodiments, such scheduling comprises scheduling uplink transmission to be performed by the one or more wireless devices collectively across all uplink portions of the unlicensed frequency band.

Alternatively or additionally, such scheduling in some embodiments comprises scheduling uplink transmission to be performed by each of the one or more wireless devices within different respective uplink portions of the unlicensed frequency band. In one embodiment, for example, the different respective uplink portions of the unlicensed frequency band are different respective frequency interlaces of the unlicensed frequency band. In this case, the method may comprise scheduling uplink transmission to be performed by at least one of the one or more wireless devices within multiple frequency interlaces of the unlicensed frequency band.

In some embodiments, scheduling comprises scheduling uplink transmission to be performed within the unlicensed frequency band during a transmission time interval by one or more of the wireless devices that each signal the unlicensed frequency band is deemed clear for the wireless device to transmit within and refraining from scheduling uplink transmission to be performed within the unlicensed frequency band during the transmission time interval by one or more of the wireless devices that each signal the unlicensed frequency band is not deemed clear for the wireless device to transmit within.

In some embodiments, the method further comprises transmitting to a first wireless device of the multiple wireless devices a first scheduling grant that schedules uplink transmission to be performed by the first wireless device within a first portion of the unlicensed frequency band and transmitting to a second wireless device of the multiple wireless devices a second scheduling grant that schedules uplink transmission to be performed by the second wireless device within a second portion of the unlicensed frequency band. In this case, the method may further comprise determining, after transmitting the first and second scheduling grants and based on said monitoring, that the unlicensed frequency band is not deemed clear for the first wireless device to transmit within and is deemed clear for the second wireless device to transmit within. Based on this determining, scheduling may comprise transmitting to the second wireless device an additional scheduling grant that schedules uplink transmission to be performed by the second wireless device within the first portion of the unlicensed frequency band.

In other embodiments, the method further comprises transmitting to a first wireless device of the multiple wireless devices information indicating a nominal assignment of the first wireless device to perform uplink transmission within a first portion of the unlicensed frequency band and transmitting to a second wireless device of the multiple wireless devices information indicating a nominal assignment of the second wireless device to perform uplink transmission within a second portion of the unlicensed frequency band. The method may also comprise determining, after transmitting the information to the first and second wireless devices and based on said monitoring, that the unlicensed frequency band is not deemed clear for the first wireless device to transmit within and is deemed clear for the second wireless device to transmit within. Based on this determining, scheduling may comprise transmitting to the second wireless device one or more scheduling grants that schedule uplink transmission to be performed by the second wireless device within both the first and second portions of the unlicensed frequency band.

In some embodiments, the method further comprises transmitting, to each of the multiple wireless devices, a request for the wireless device to signal whether the unlicensed frequency band is deemed clear for the wireless device to transmit within.

In some embodiments, the method further comprises transmitting, to each of the multiple wireless devices, information indicating a duration of the measurement to be performed by the wireless device over the unlicensed frequency band.

In some embodiments, scheduling comprises transmitting a scheduling grant indicating said scheduling to a wireless device that signals the unlicensed frequency band is deemed clear for the wireless device to transmit within. In this case, the method may further comprise receiving, from the wireless device, a sounding reference signal after transmitting the scheduling grant but before receiving the scheduled uplink transmission from the wireless device.

Alternatively or additionally, scheduling may comprise transmitting a scheduling grant indicating said scheduling to a wireless device that signals the unlicensed frequency band is deemed clear for the wireless device to transmit within. The scheduling grant may indicate a time at which the scheduled uplink transmission is to be started by the wireless device and indicate whether a sounding reference signal is to be transmitted after the scheduling grant but before the scheduled uplink transmission.

In some embodiments, the method further comprises determining, based on a measurement performed by the radio network node over the unlicensed frequency band, whether the unlicensed frequency band is deemed clear for transmitting within. In this case, said monitoring and scheduling may be performed responsive to determining that the unlicensed frequency band is deemed clear for transmitting within. The measurement performed by the radio network node is longer than the measurement performed by the wireless device.

Embodiments herein also include a method performed by a wireless device configured for use in a wireless communication system. The method comprises determining, based on a measurement performed by the wireless device over an unlicensed frequency band, whether the unlicensed frequency band is deemed clear for the wireless device to transmit within. The method also comprises signaling to a radio network node whether the unlicensed frequency band is deemed clear for the wireless device to transmit within according to said determining. In some embodiments, the method may also comprise, responsive to signaling that the unlicensed frequency band is deemed clear for the wireless device to transmit within, receiving a scheduling grant from the radio network node that schedules uplink transmission to be performed by the wireless device within one or more portions of the unlicensed frequency band and performing the uplink transmission according to the scheduling grant.

In some embodiments, the method further comprises, before said signaling, receiving from the radio network node another scheduling grant that schedules uplink transmission to be performed by the wireless device within a nominal portion of the unlicensed frequency band, such that the scheduling grant received responsive to said signaling schedules uplink transmission to be performed by the wireless device within one or more additional portions of the unlicensed frequency band.

In other embodiments, the method further comprises, before said signaling, receiving from the radio network node information indicating a nominal assignment of the wireless device to perform uplink transmission within a nominal portion of the unlicensed frequency band, wherein the scheduling grant received responsive to said signaling schedules uplink transmission to be performed by the wireless device within the nominal portion as well as one or more additional portions of the unlicensed frequency band.

In some embodiments, the method may further comprise, before receiving the scheduling grant, preparing for uplink transmission within the nominal portion, and, after receiving the scheduling grant, performing uplink transmission within the nominal portion before performing uplink transmission within the one or more additional portions.

The method may alternatively or additionally further comprise receiving from the radio network node a request for the wireless device to signal whether the unlicensed frequency band is deemed clear for the wireless device to transmit within. In this case, said determining and signaling are performed in response to the request.

In some embodiments, the method further comprises, after receiving the scheduling grant but before performing the scheduled uplink transmission, transmitting a sounding reference signal. In one embodiment, for instance, the scheduling grant indicates a time at which uplink transmission is to be started by the wireless device and indicates whether a sounding reference signal is to be transmitted after the scheduling grant but before the uplink transmission.

In some embodiments, the one or more portions of the unlicensed frequency band comprise one or more frequency interlaces of the unlicensed frequency band.

In some embodiments, the method further comprises receiving from the radio network node information indicating a duration of the measurement to be performed by the wireless device over the unlicensed frequency band, and performing the measurement for the indicated duration.

Embodiments herein also include corresponding apparatus, computer programs, and carriers (e.g., non-transitory computer readable mediums).

For example, embodiments herein include a radio network node configured for use in a wireless communication system. The radio network node (e.g., via processing circuitry and communication circuitry of the radio network node) is configured to monitor for signaling, from each of multiple wireless devices that are candidates for performing uplink transmission within an unlicensed frequency band, indicating whether the unlicensed frequency band is deemed clear for the wireless device to transmit within according to a measurement performed by the wireless device over that unlicensed frequency band. The radio network node is also configured to schedule, based on said monitoring, uplink transmission within the unlicensed frequency band to be performed by one or more of the wireless devices that each signal the unlicensed frequency band is deemed clear for the wireless device to transmit within.

Embodiments also include a wireless device configured for use in a wireless communication system. The wireless device (e.g., via processing circuitry and communication circuitry of the wireless device) is configured to determine, based on a measurement performed by the wireless device over an unlicensed frequency band, whether the unlicensed frequency band is deemed clear for the wireless device to transmit within. The wireless device is also configured to signal to a radio network node whether the unlicensed frequency band is deemed clear for the wireless device to transmit within according to said determining. The wireless device in some embodiments is further configured to, responsive to signaling that the unlicensed frequency band is deemed clear for the wireless device to transmit within, receive a scheduling grant from the radio network node that schedules uplink transmission to be performed by the wireless device within one or more portions of the unlicensed frequency band and perform the uplink transmission according to the scheduling grant.

### BRIEF DESCRIPTION OF THE DRAWINGS

FIG. 1 is a block diagram of a wireless communication system according to some embodiments.

FIG. 2A is a block diagram of an example grouping of wireless devices according to which devices deem the unlicensed frequency band clear, according to some embodiments.

FIG. 2B is a block diagram of an example uplink scheduling according to some embodiments.

FIG. 2C-2D are block diagrams of an example uplink scheduling according to other embodiments that employ multiple iterations or passes of scheduling.

FIGS. 2E-2F are block diagrams of an example uplink scheduling according to other embodiments that employ nominal assignment followed by scheduling.

FIG. 3 is a block diagram illustrating an example uplink scheduling according to some embodiments employing a long LBT by a radio network node and a short LBT by wireless devices.

FIG. 4A is a logic flow diagram of a method performed by a radio network node according to some embodiments.

FIG. 4B is a logic flow diagram of a method performed by a wireless device according to some embodiments.

FIG. 5 is a block diagram illustrating an example uplink scheduling according to some embodiments where wireless devices receive sensing feedback of other wireless devices in a full-duplex manner.

FIG. 6 is a block diagram illustrating an example uplink scheduling according to some embodiments where wireless devices receive sensing feedback of other wireless devices in a half-duplex manner.

FIG. 7 is a block diagram of a radio network node according to some embodiments.

FIG. 8 is a block diagram of a radio network node according to other embodiments.

FIG. 9 is a block diagram of a wireless device according to still other embodiments.

FIG. 10 is a block diagram of a wireless device according to yet other embodiments.

FIG. 11 is a block diagram of a wireless communication network according to some embodiments.

FIG. 12 is a block diagram of a user equipment according to some embodiments.

FIG. 13 is a block diagram of a virtualization environment according to some embodiments.

FIG. 14 is a block diagram of a communication network with a host computer according to some embodiments.

FIG. 15 is a block diagram of a host computer according to some embodiments.

FIG. 16 is a flowchart illustrating a method implemented in a communication system, in accordance with one embodiment.

FIG. 17 is a flowchart illustrating a method implemented in a communication system, in accordance with one embodiment.

FIG. 18 is a flowchart illustrating a method implemented in a communication system, in accordance with one embodiment.

FIG. 19 is a flowchart illustrating a method implemented in a communication system, in accordance with one embodiment.

### DETAILED DESCRIPTION

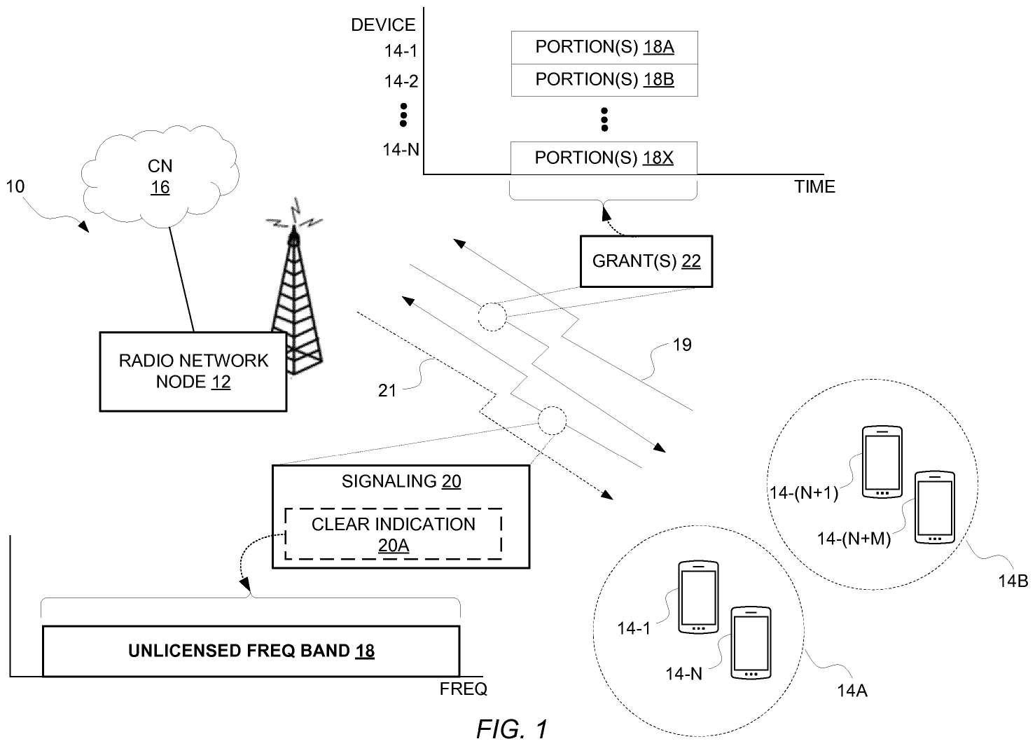

FIG. 1 shows a wireless communication system 10 according to some embodiments. The system 10 includes a radio access node 12 (e.g., a base station) that wirelessly communicates with wireless devices. FIG. 1 in particular shows N+M wireless devices labeled as 14-1 to 14-(N+M), which will collectively be referred to as wireless devices 14. The radio access node 12 connects the wireless devices 14 to a core network (CN) 16. The CN 16 in turn connect the wireless devices 14 to one or more data networks, e.g., the Internet, a public switched telephone network (PSTN), etc.

The system 10 is configured to use an unlicensed frequency band 18, e.g., to supplant or supplement a licensed frequency band (not shown). The system 10 may be for instance a Licensed Assisted Access (LAA) system, a Multefire system, an LTE-WLAN Aggregation (LWA) system, or the like. The unlicensed frequency band 18 is unlicensed in the sense that no one has exclusive rights to use the frequency band, e.g., no one party has purchased such rights. As a consequence of the unlicensed nature of the frequency band 18, the frequency band 18 is shared such that anyone is free to use the frequency band at any time. This means that transmissions in the frequency band are susceptible to interference. Examples of unlicensed frequency bands in the United States include a band at 2.4 GHz and bands at or near 5 GHz. The unlicensed frequency band 18 in some contexts may be referred to as a bandwidth part (BWP), which may for instance have a bandwidth of 20 MHz.

In any event, to combat interference in the unlicensed frequency band 18, at least some transmissions in the band 18 can only be performed after sensing that the band 18 is clear for those transmissions. Such sensing may be implemented for instance according to a clear channel assessment (CCA) or listen before talk (LBT) procedure.

According to some embodiments herein, wireless devices 14 each signal to the radio network node 12 whether they sense or detect the unlicensed frequency band 18 as clear for them to transmit within, e.g., by signaling the outcome of their respective CCA or LBT procedures to the radio network node 12. Wireless devices 14 may do so for instance in response to a request by the radio network node 12 for such signaling. Some of the wireless devices 14 in this regard may detect the band 18 as clear while other wireless devices 14 do not, e.g., due to the wireless devices 14 having different path losses to any source(s) already transmitting within the unlicensed frequency band 18. In any event, the radio network node 12 notably leverages this signaling to schedule uplink transmission 19 by one or more of the wireless devices 14 within the unlicensed frequency band 18, e.g., in a frequency division multiplexing (FDM) or block-interleaved frequency division multiple access (BI-FMDA) fashion.

The radio network node 12 may do so in a way that prevents portions of the unlicensed frequency band 18 from being wasted due to non-use by those of the wireless devices 14 that end up not being able to transmit within the unlicensed frequency band 18. In fact, the radio network node 12 may schedule uplink transmission 19 in this way so as to allow those wireless devices 14 which signal the unlicensed frequency band 18 as clear to use portions of the unlicensed frequency band 18 that would not (or could not) be used by those wireless devices 14 which do not signal the unlicensed frequency band 18 as clear. This may correspondingly increase the achievable system performance, e.g., in terms of transmission data rate attainable by a wireless device 14.

More particularly, FIG. 1 shows that the radio network node 12 considers the N+M wireless devices 14 as candidates for performing uplink transmission 19 within the unlicensed frequency band 18, e.g., during a given transmission time interval (TTI). To support the radio network node's uplink transmission scheduling, these wireless devices 14 each perform a measurement (e.g., as part of its CCA or LBT procedure) over the unlicensed frequency band 18 to determine whether the band 18 is deemed clear for the device 14 to transmit within.

The radio network node 12 correspondingly monitors for signaling 20 from each of the candidate wireless devices 14 indicating whether the unlicensed frequency band 18 is deemed clear for the device 14 to transmit within according to the device's measurement. The signaling 20 as shown for instance includes a “clear indication” field that indicates whether or not the unlicensed frequency band 18 is deemed clear. In other embodiments, though, the signaling 20 may constitute a single predefined value, sequence, or other signal whose reception at the radio network node 12 from a certain device indicates that the unlicensed frequency band 18 is deemed clear for that device. In this and other embodiments, the radio network node 12 may deduce that the unlicensed frequency band 18 is not deemed clear for any device from whom the radio network node 12 does not receive such signaling 20, e.g., within an expected time frame during which the radio network node 12 monitors for the signaling 20. Accordingly, a wireless device 14 in these embodiments implicitly signals whether the unlicensed frequency band 18 is deemed clear for the device 14 to transmit within by transmitting or refraining from transmitting signaling 20. Either way, the radio network node 12 may monitor for signaling 20 after sending a request 21 for the signaling 20 to one or more of the candidate devices 14, monitor for signaling 20 during certain (predefined) time periods in which the signaling 20 is expected to be transmitted in an unsolicited manner, or the like.

Based on monitoring for this signaling 20, the radio network node 12 schedules uplink transmission 19 within the unlicensed frequency band 18. The radio network node 12 in particular schedules uplink transmission 19 within the unlicensed frequency band 18 to be performed by one or more of the wireless devices 14 that each signal the unlicensed frequency band 18 is deemed clear for the wireless device 14 to transmit within. In fact, in some embodiments, the radio network node 12 effectively schedules (e.g., using one or more scheduling iterations or passes) uplink transmission 19 to be performed by only those of the wireless devices 14 that signal they detect the unlicensed frequency band 18 as clear.

FIG. 1 as an example shows that N devices 14-1 through 14-N each signal the unlicensed frequency band 18 is deemed clear for the device 14 to transmit within (N≥1). These N devices will be referred to as “cleared” wireless devices 14A since those devices report the unlicensed frequency band 18 as being cleared for them to transmit within. FIG. 1 also shows that M devices 14-(N+1) through 14-(N+M) each do not signal the unlicensed frequency band 18 is deemed cleared for the device 14 to transmit within (M≥0); that is, they either do not transmit signaling 20 or their signaling 20 indicates the unlicensed frequency band 18 is not deemed clear. These M devices will be referred to as “uncleared” wireless devices 14A since the reports indicate the unlicensed frequency band 18 as not being cleared for them to transmit within.

In FIG. 1's example, the radio network node 12 effectively schedules (e.g., using one or more scheduling iterations or passes) uplink transmission 19 to be performed within the unlicensed frequency band 18 by only the cleared wireless devices 14A, i.e., not the uncleared wireless devices 14B. The radio network node 12 in this regard schedules uplink transmission 19 to be performed by the N cleared wireless devices 14A within respective portions (e.g., frequency blocks or interlaces) of the unlicensed frequency band 18. Indeed, as shown, the radio network node 12 schedules uplink transmission to be performed by wireless device 14-1 within one or more portions 18A of the unlicensed frequency band 18, by wireless device 14-2 within one or more portions 18B of the unlicensed frequency band 18, and so on up to wireless device 14-N within one or more portions 18X. The scheduling in some sense then allocates respective portions of the unlicensed frequency band 18 to cleared wireless devices 14A for uplink transmission. The radio network node 12 in some embodiments implements or carries out this scheduling by transmitting one or more scheduling grants 22 (also referred to as uplink grants) to the cleared wireless devices 14A, e.g., in order to indicate to the wireless devices 14A on which portion(s) of the unlicensed frequency band 18 to transmit.

The radio network node 12 may effectively schedule uplink transmission to be performed by only the cleared wireless devices 14A as described above in any number of possible ways. In some embodiments, for example, the radio network node waits to schedule uplink transmission 19 that will be performed within the unlicensed frequency band 18 (e.g., during a certain TTI) until after the radio network node 12 receives signaling 20 (or until after expiration of an expected time period for receiving that signaling 20). Waiting for this signaling 20 enables the radio network node 12 to perform a single-pass at uplink scheduling with full knowledge of which wireless devices 14A deem the unlicensed frequency band 18 clear. In these embodiments, then, the radio network node 12 may avoid ever scheduling uplink transmission to be performed within the unlicensed frequency band 18 (e.g., during a certain TTI) by wireless devices 14B that do not deem the unlicensed frequency band 18 clear.

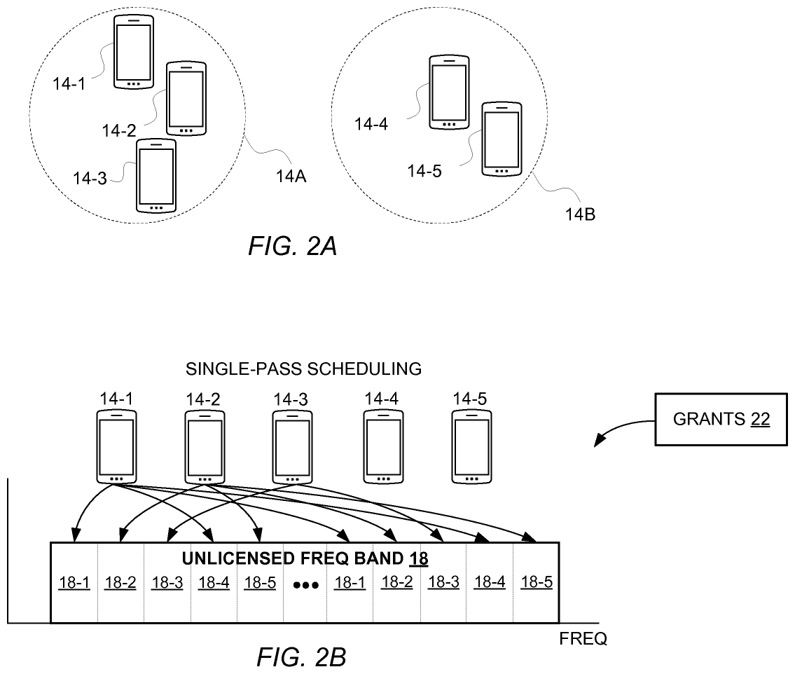

FIGS. 2A-2B illustrate an example of this. In this example, as FIG. 2A shows, the number N of cleared wireless devices 14A is three in the form of devices 14-1, 14-2, and 14-3, and the number M of uncleared wireless devices 14B is two in the form of devices 14-4 and 14-5. The radio network node 12 accordingly receives signaling 20 from each of the devices 14-1, 14-2, and 14-3 indicating that the unlicensed frequency band 18 is deemed clear. And the radio network node 12 either does not receive signaling 20 from either of devices 14-4 or 14-5 (e.g., within an expected time frame for receiving it), or does receive signaling 20 from those devices 14-4 and 14-5 but the signaling 20 indicates that the unlicensed frequency band 18 is not deemed clear.

FIG. 2B shows the result of uplink scheduling in embodiments where the radio network node 12 waits to schedule uplink transmission 19 (e.g., for a certain TTI) until after the radio network node 12 receives signaling 20 (or until after an expected time frame for receiving the signaling 20). Because the radio network node 12 waits, the radio network node 12 schedules (e.g., in a single iteration or pass) uplink transmission to be performed within the unlicensed frequency band 18 by only the cleared wireless devices 14-1, 14-2, and 14-3, not the uncleared wireless devices 14-4 and 14-5. The radio network node 12 therefore sends grants 22 to only the cleared wireless devices. As shown in FIG. 2B, for example, the radio network node 12 (as indicated by grants 22) schedules uplink transmission 19 to be performed by cleared device 14-1 within portions 18-1 and 18-4 of the unlicensed frequency band 18, schedules uplink transmission 19 to be performed by cleared device 14-2 within portions 18-2 and 18-5 of the unlicensed frequency band 18, and schedules uplink transmission 19 to be performed by cleared device 14-3 within portion 18-3 of the unlicensed frequency band 18. These portions 18-1, 18-2, 18-3, 18-4, and 18-5 are shown as frequency interlaces in the unlicensed frequency band 18, e.g., according to BI-FDMA. Because the radio network node 12 does not schedule uplink transmission to be performed by any of the uncleared wireless devices 14-4 or 14-5 within the unlicensed frequency band 18, the radio network node 12 is able to allocate more bandwidth in the unlicensed frequency band 18 to one or more of the cleared wireless devices 14-1, 14-2, and 14-3. As shown in this example, for instance, the radio network node 12 allocates more portions to cleared devices 18-1 and 18-2, than possible if the uncleared wireless devices 14-4 and 14-5 would have been allocated bandwidth too. Although not shown, of course, the radio network node 12 in other embodiments may allocate the same number of portions to cleared devices 18-1, 18-2, and 18-3, but allocate to at least some of the cleared devices portions with more bandwidth.

Consider now even other embodiments for how the radio network node 12 may effectively schedule uplink transmission to be performed by only the cleared wireless devices 14A, e.g., after multiple iterations or passes of scheduling. In these embodiments, the radio network node 12 may initially schedule uplink transmission without regard to signaling 20, but then re-schedule as needed to account for the signaling 20 once it is received. In this case, the “first-pass” initial scheduling may allocate different portions (e.g., interlaces) of the unlicensed frequency band 18 to different wireless devices 14 (including devices that may end up being uncleared), but after the signaling 20 is received the “second-pass” re-scheduling may re-allocate the portions given to wireless devices 14B that do not end up signaling the unlicensed frequency band 18 as clear. Indeed, those portions may be re-allocated to the cleared wireless devices 14A that did signal the unlicensed frequency band as clear. FIGS. 2C and 2D illustrate example first and second passes of uplink scheduling according to some of these embodiments.

As shown in the example of FIG. 2C, the radio network node's first pass at scheduling schedules uplink transmission to be performed by devices 14-1, 14-2, 14-3, 14-4, and 14-5 within respective portions 18-1, 18-2, 18-3, 18-4, and 18-5 of the unlicensed frequency band 18. This first pass therefore does not distinguish between which devices are or will be cleared and which devices are or will be uncleared. In fact, the first pass may be performed before receiving signaling 20 used to determine that distinction. The radio network node 12 may even transmit scheduling grants 22-1 to the devices indicating this scheduling. The scheduling indicated by these first scheduling grants 22-1 may be nominal or conditional in the sense that it is subject to clearance of the unlicensed frequency band 18 (e.g., a successful CCA or LBT) and thereby effectively subject to override by subsequent scheduling grants. In some embodiments, the scheduling grants 22-1 are transmitted with or accompanied by a request for signaling 20 from the devices 14-1 through 14-5.

Indeed, after the radio network node 12 receives signaling 20 (or after expiration of an expected time frame for receiving signaling 20), the radio network node 12 deduces that devices 14-4 and 14-5 are uncleared and therefore cannot actually perform the uplink transmission for which they were scheduled in the first pass. Indeed, any scheduling grants 22-1 transmitted to devices 14-4 and 14-5 will go unused. Accordingly, the radio network node 12 performs a second pass at scheduling as shown in FIG. 2D. In this second pass, the radio network node 12 schedules uplink transmission to be performed by one or more of the cleared devices 14-1, 14-2, and 14-3 within portions 14-4 and 14-5; that is, the portions 14-4 and 14-5 that would have gone unused by uncleared devices 14-4 and 14-5. FIG. 2D for instance shows the radio network node 12 subsequently transmits additional grants 22-2 that schedule uplink transmission to be performed by cleared devices 14-1 and 14-2 within respective portions 14-4 and 14-5 of the unlicensed frequency band 18.

The combined effect of scheduling grants 22-1 and 22-2 therefore is that uplink transmission is scheduled to be performed by only cleared wireless devices 14-1, 14-2, and 14-3. In fact, uplink transmission may be scheduled in this way to be performed by the cleared wireless devices collectively across all portions 14-1 through 14-5 of the unlicensed frequency band 18, or at least those portions that are “uplink portions” on which uplink transmission can be performed (i.e., not including any other “downlink” portions within the unlicensed frequency band 18). This enables the radio network node 12 to ensure full use of the uplink transmission bandwidth in the unlicensed frequency band 18, so that no uplink bandwidth goes wasted. Moreover, uplink transmission is scheduled to be performed by at least some of the cleared wireless devices within multiple portions (e.g., frequency interlaces) of the unlicensed frequency band 18. Indeed, in this example, uplink transmission is scheduled to be performed by cleared device 14-1 within portions 18-1 and 18-4, and to be performed by cleared device 14-2 within portions 18-2 and 18-5. This additional bandwidth may increase the devices' respective transmission data rates and/or robustness to channel conditions.

In some embodiments, the multi-pass scheduling approach exemplified by FIGS. 2C and 2D proves useful for a wireless device 14 to quickly occupy the unlicensed frequency band 18, e.g., so as to reduce the risk of a competing device occupying the band 18 and causing interference. In some embodiments, for example, after a wireless device 14 receives a first scheduling grant 22-1 and determines the unlicensed frequency band 18 is clear, the wireless device 14 may quickly begin its uplink transmission 19 on the portion of the unlicensed frequency band 18 allocated by that first scheduling grant 22-1, even before having received any additional scheduling grant 22-2. If or when the wireless device 14 later receives an additional grant 22-2, the wireless device 14 may then begin uplink transmission 19 on any additional portion of the unlicensed frequency band 18 allocated by that later grant. The wireless device 14 may therefore be configured to begin uplink transmission 19 on the initially allocated portion of the unlicensed frequency band 18 before beginning uplink transmission 19 on any subsequently allocated portions of the unlicensed frequency band 18.

Other embodiments shown in FIGS. 2E-2F have a similar effect but without multiple passes or iterations of scheduling. Rather than actually scheduling uplink transmission to be performed by devices 14 within respective portions of the unlicensed frequency band 18 in a first pass, the radio network node 12 in these other embodiments may simply transmit nominal assignment information 24 to those devices 14 indicating the nominal assignment of those portions to the devices 14. The nominal assignment information 24 may for instance be preconfigured, or transmitted with or accompanied by a request for signaling 20 from the wireless devices 14-1 through 14-5. Regardless, this nominal assignment falls short of actually scheduling a device 14 for uplink transmission on a portion, such that it serves more as just advanced notice that the device 14 might later receive a scheduling grant for that portion if the device senses the unlicensed frequency band 18 as clear. Otherwise, uplink transmission will be scheduled to be performed on that portion by a different wireless device that does sense the unlicensed frequency band 18 as clear. As shown in FIG. 2E, for instance, the radio network node 12 later transmits scheduling grants 22 to cleared wireless devices 14-1, 14-2, and 14-3 that schedule uplink transmission to be performed by those devices. In particular, the grant 22 to device 14-1 schedules uplink transmission to be performed by that device 14-1 within not only the portion 18-1 that was nominally assigned to device 14-1 but also the portion 18-4 that was nominally assigned to now-uncleared device 14-4. And the grant 22 to device 14-2 schedules uplink transmission to be performed by that device 14-2 within not only the portion 18-2 that was nominally assigned to device 14-2 but also the portion 18-5 that was nominally assigned to now-uncleared device 14-5. The grant 22 to device 14-3 may simply schedule uplink transmission to be performed by device 14-3 on the portion 18-3 nominally assigned to that device 14-3, e.g., based on device 14-3 or a service to which its uplink transmission relates having lower priority than devices 14-1 and 14-2 or the services to which their uplink transmissions relate.

In some embodiments, the approach exemplified by FIGS. 2E and 2F similarly proves useful for a wireless device 14 to quickly occupy the unlicensed frequency band 18. For example, after a wireless device 14 receives its nominal assignment 24 (and possibly also after the device 14 determines the unlicensed frequency band 18 is clear), the wireless device 14 may prepare its uplink transmission 19 to be transmitted (e.g., by generating packets of the transmission 19). This way, as soon as the wireless device 14 receives a scheduling grant 22, the wireless device 14 may quickly begin its already prepared uplink transmission 19 on the portion nominally assigned. If the uplink transmission 19 is also scheduled to be performed on any additional portion of the unlicensed frequency band 18, the wireless device 14 may at that point prepare for and perform uplink transmission on the additional portion(s) after having already begun uplink transmission on the nominally assigned portion. The wireless device 14 may therefore be configured to begin uplink transmission 19 on the nominally assigned portion of the unlicensed frequency band 18 before beginning uplink transmission 19 on any subsequently assigned portions of the unlicensed frequency band 18.

Still other embodiments herein enable a wireless device 14 to quickly occupy the unlicensed frequency band 18 by transmitting a reference signal before the device 14 is ready to perform its uplink transmission 19 (e.g., due to processing delays at the device 14). After receiving a scheduling grant, for example, a cleared wireless device 14 may quickly transmit a reference signal, e.g., a sounding reference signal. This allows the wireless device 14 to occupy the unlicensed frequency band 18 even while the device 14 prepares its uplink transmission. When the uplink transmission is ready, the device 14 may perform the uplink transmission.

In some embodiments, the radio network node 12 controls whether the wireless device 14 is to transmit such a reference signal after receiving a scheduling grant but before performing the uplink transmission. In one embodiment, for instance, the scheduling grant indicates a time at which the uplink transmission is to be started and indicates (e.g., via a flag) whether a reference signal is to be transmitted after the scheduling grant but before the scheduled uplink transmission. In fact, if the reference signal is transmitted on the same portion(s) of the unlicensed frequency band 18 as the uplink transmission 19 will be, the radio network node 12 in some embodiments uses the reference signal to improve its channel estimation for the uplink transmission.

Embodiments that allow a wireless device 14 to quickly occupy the unlicensed frequency band 18 may prove particularly useful if regulations, standards, or other rules governing use of the unlicensed frequency band 18 require the wireless device 14 to occupy the band 18 within a certain amount of time after sensing the band 18 is clear, or else the device 14 must sense the band 18 is clear again (or sense the band 18 again with a longer measurement). Accordingly, if the rules allow and either a cleared device's processing time is short enough or the device occupies the unlicensed frequency band 18 quickly enough after clearance, the device 14 may omit further or longer clearance sensing of the band 18 and start its uplink transmission as soon as possible.

In other embodiments, though, regulations, standards, or other rules require any device 14 to sense the unlicensed frequency band 18 as clear every time the device 14 switches between uplink and downlink. In this case, then, further clearance sensing of the band 18 may be unavoidable and has the potential to conflict with previous clearance sensing of the band 18. For example, a device 14 may signal to the radio network node 20 that the band 18 is clear and receive a scheduling grant based on such clearance, but then detect that the band 18 is not clear before actually performing the scheduled uplink transmission. Some embodiments minimize the probability of this occurring by minimizing the amount of time between a wireless device 14 transmitting signaling 20 and the radio network node 12 transmitting a scheduling grant. In the unlikely event that a conflict occurs between clearance outcomes, a wireless device 14 may be configured to discard the scheduling grant and back off its uplink transmission.

Some of the above-described embodiments may be implemented in a context where the radio network node 12 itself first senses the uplink frequency band 18 (e.g., with a long LBT procedure) as clear in order to grab the band 18 for a certain amount of time (e.g., the maximum channel occupancy time, MOOT, or transmission opportunity, TXOP). The radio network node 12 then “shares” that time with the wireless devices 14 so that the devices 14 can perform uplink transmission within the band 18 during the time for which the radio network node 12 has grabbed the band 18. This way, the wireless devices 14 may only be required to sense the band 18 as clear fora shorter amount of time (e.g., with a short LBT procedure) prior to performing uplink transmission. In this context, the signaling 20 from a wireless device 14 indicates whether the uplink frequency band 18 is deemed clear according to a “short” clearance measurement.

More generally, then, the radio network node 12 in some embodiments first determines, based on a “long” measurement performed by the radio network node 12 over the unlicensed frequency band 18, whether the band 18 is deemed clear for transmitting within. If so, the radio network node 12 may occupy the band 18 (e.g., by transmitting a request for signaling 20) in order to grab the band 18 for a certain time period. The radio network node 12 may then monitor for signaling 20 from wireless devices 14 indicating whether the wireless devices themselves deem the band 18 clear according to their respective “short” measurements. The radio network node's “long” measurement in this regard is longer than the “short” measurements performed by the devices 14. After determining which devices 14 cleared the band 18, the radio network node 12 then schedules uplink transmission to be performed by those cleared devices 14A within the band 18 during the time period for which the radio network node 12 grabbed the band 18.

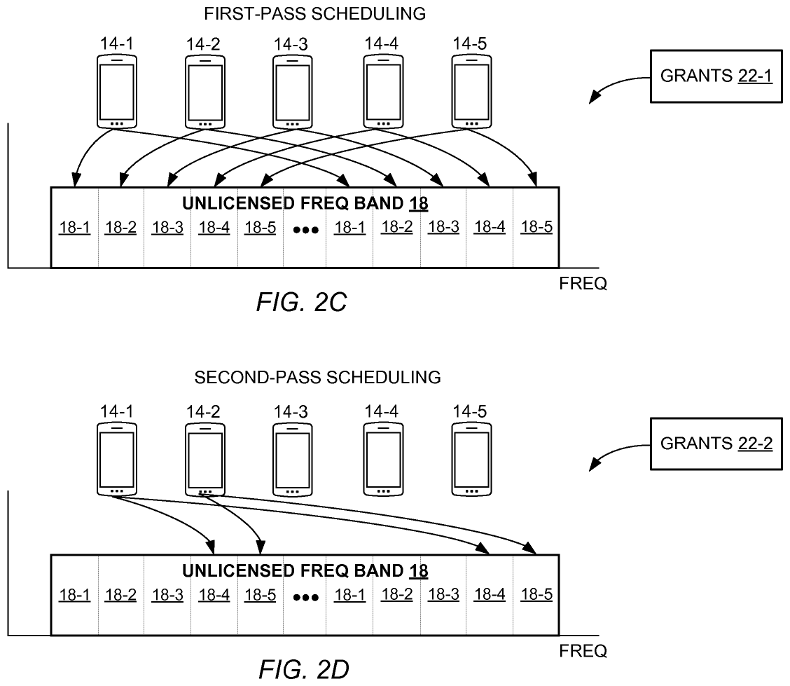

FIG. 3 illustrates an example of one or more of these embodiments. In this example, the radio network node 12 schedules uplink transmission to be performed by wireless devices in respective frequency interlaces, e.g., according to a block interleaved FDMA approach. This may be to comply for instance with ETSI regulations that mandate a limit on the maximum transmit power and the power spectral density (PSD), e.g., in the 5 GHz band it is limited to 10 dBm per 1 MHz. This use of interlaces may allow the wireless devices to use the full output power for a small bandwidth allocation.

As an example in a context where the system 10 is a NR Unlicensed (NR-U) system, if the unlicensed frequency band 18 has a bandwidth of 20 MHz and a subcarrier spacing of 30 kHz, the total number of effective physical resource blocks (PRBs) after taking into account any guard bands is 51, each consisting of 12 subcarriers. These 51 PRBs may be divided into N=5 interlaces, each interlace consisting of M=10 PRBs (with the first interlace being an extra PRB). If the 5 interlaces are allocated to 5 wireless devices, then according to regulations, the maximal output power from a wireless device with 10 interleaved PRBs is: 10 (for each PRB, whose bandwidth is smaller than 1 MHz)+10 log 10(10)=20 dBm. By contrast, if instead of interlace allocation each wireless device were to be allocated with 10 contiguous PRBs, the allowed output power from each device would have been: 10+10 log 10(10*12*30e3/1e6))=15.6 dBm.

With this in mind, the radio network node 12 in the example of FIG. 3 performs scheduling based on feedback from the wireless devices, in order to allocate the available interlaces to only available wireless devices 14A; namely, to only wireless devices 14A that sense the unlicensed frequency band 18 as free and signal such as sensing feedback (SF) to the radio network node 12.

In particular, as shown in FIG. 3, the radio network node 12 performs a “long” LBT 26 over the unlicensed frequency band 18 during multiple subframes of a radio frame. Upon the LBT 26 indicating the unlicensed frequency band 18 is clear, the radio network node 12 sends a sensing request (SR) to wireless devices 14-1 through 14-5 requesting that the devices respond with signaling 20 indicating the outcome of their respective LBTs on the band 18. In this example, wireless devices 14-1 and 14-4 perform their respective LBTs 30-1 and 30-4 with an outcome that the unlicensed frequency band 18 is not deemed clear. These unclear devices 14-1 and 14-4 therefore refrain from transmitting signaling 20 in the form of sensing feedback (SF) to the radio network node 12 and back off their uplink transmissions. By contrast, wireless devices 14-2, 14-3, and 14-5 perform their respective LBTs 30-2, 30-3, and 30-5 with an outcome that the unlicensed frequency band 18 is deemed clear. Accordingly, these clear devices 14-2, 14-3, and 14-5 transmit signaling 20 in the form of sensing feedback (SF) 32-2, 32-3, and 32-5 indicating their LBT outcomes. The devices 14-1 through 14-6 may have different LBT outcomes for instance due to the geographically distributed nature of the devices.

In some embodiments, multiple devices signal their SFs simultaneously in this way using code division multiplexing (CDM) or interlace multiplexing. Which code sequence or interlace to be used for each wireless device may be pre-configured and associated with the devices' respective ID in the SR. Moreover, the device's ID may also be included in the SFs so that the radio network node 12 can distinguish SFs from different UEs.

Regardless, the radio network node 12 receives SF 32-2, 32-3, and 32-5 and determines based on that SF that devices 14-2, 14-3, and 14-5 deem the band 18 clear. After not receiving SF from devices 14-1 and 14-4 within an allowed time frame, the radio network node 12 declares those devices do not deem the band 18 clear and are unavailable for uplink transmission. The radio network node 12 correspondingly performs a short LBT 34 and, upon its success, transmits scheduling grant(s) (SG) 36 to available devices 14-2, 14-3, and 14-5 scheduling uplink transmission to be performed by those devices. The SG 36 in this regard schedules device 14-2 to perform uplink transmission on interlaces 1 and 2, schedules device 14-3 to perform uplink transmission on interlaces 3 and 4, and schedules device 14-5 to perform uplink transmission on interlace 5. Effectively, then, device 14-2 is allocated the interlace (namely, interlace 1) that would have been allocated to device 14-1 had it been available for uplink transmission, and device 14-3 is allocated the interlace (namely, interlace 4) that would have been allocated to device 14-4 had it been available for uplink transmission. Upon receiving the SG 36, and after being required to perform short LBT 38-2, 38-3, and 38-5 prior to beginning uplink transmission (or possibly to skip LBT if the gaps between downlink and uplink transmissions are small enough), the devices 14-2, 14-3, and 14-5 perform uplink transmission (UL TX) 40-2, 40-3, and 40-5 on the interlaces respectively allocated to them.

Although not shown in this example, the radio network node 12 in some embodiments transmits signaling to a wireless device 14 to distinguish the shared occupancy case in which the devices 14 need only perform a relatively short clearance measurement from the normal, unshared occupancy case in which the devices 14 must perform a relatively long clearance measurement. For example, in some embodiments, the radio network node 12 transmits, to each of the multiple wireless devices 14, information indicating a length or duration of the (clearance) measurement to be performed by the wireless device 14 over the unlicensed frequency band 18. Where the measurement is an LBT measurement, for instance, the information may indicate a category of the LBT procedure to be performed, e.g., as long or short LBT. In embodiments where the radio network node 12 transmits a request to a wireless device 14 for signaling 20, this information may be included in the request. If different devices 14 are to perform measurements of different lengths, the request may indicate (e.g., with individual device identifiers) which devices 14 are to perform which length measurements. The signaling in this embodiment may additionally or alternatively be used if the radio network node 12 schedules uplink transmission to start a long time (e.g., more than 16 us) after a previous transmission.

Note also that the wireless devices 14 can be configured to sense and report its CCA or LBT outcome for only a certain part of or the whole unlicensed frequency band 18. For example, in embodiments where wireless devices 14 are scheduled to perform uplink transmission on portions of the unlicensed frequency band 18 that constitute frequency interlaces, the wireless devices 14 are configured in some embodiments to sense the band 18 as a whole, not just sense certain frequency interlaces. Where the unlicensed frequency band 18 is a 20 MHz BWP, for instance, a wireless device 14 measures and reports CCA or LBT for the whole 20 MHz BWP, instead of just certain interlaces (e.g., nominally assigned interlaces).

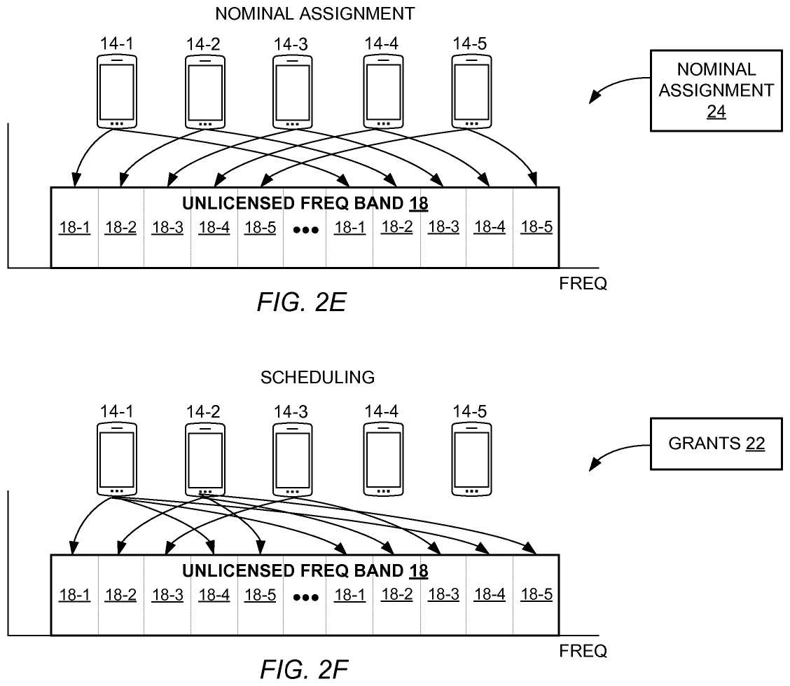

In view of the above modifications and variations, FIG. 4A shows a method performed by a radio network node 12 configured for use in a wireless communication system 10 according to some embodiments. The method may comprise monitoring for signaling 20, from each of multiple wireless devices 14 that are candidates for performing uplink transmission within the unlicensed frequency band 18, indicating whether the unlicensed frequency band 18 is deemed clear for the wireless device 14 to transmit within according to a measurement performed by the wireless device 14 over that unlicensed frequency band 18 (Block 110). The method may also comprise scheduling, based on that monitoring, uplink transmission within the unlicensed frequency band 18 to be performed by one or more of the wireless devices 14A that each signal the unlicensed frequency band 18 is deemed clear for the wireless device to transmit within (Block 120).

In some embodiments, the method may also comprise the radio network node 12 performing a measurement over the unlicensed frequency band 18 in order to determine whether the unlicensed frequency band 18 is deemed clear for transmitting within (Block 105). The monitoring and scheduling steps may be performed if the band 18 is deemed clear, but otherwise may not be performed. This measurement by the radio network node 12 may be longer in duration than the measurement performed by the wireless devices 14.

Alternatively or additionally, the method may further comprise transmitting, to each of the multiple wireless devices 14, a request for the wireless device 14 to signal whether the unlicensed frequency band 18 is deemed clear for the wireless device to transmit within (Block 105).

FIG. 4B shows a corresponding method performed by a wireless device 14 according to some embodiments. The method includes determining, based on a measurement performed by the wireless device 14 over the unlicensed frequency band 18, whether the unlicensed frequency band 18 is deemed clear for the wireless device to transmit within (Block 210). The method also comprises signaling to a radio network node 12 whether the unlicensed frequency band 18 is deemed clear for the wireless device to transmit within according to that determining (Block 220). In some embodiments, for example, this signaling involves transmitting signaling 20 indicating the band 18 is deemed clear or refraining from transmitting signaling 20 in order to indicate the band 18 is not deemed clear.

Regardless, the method may further include, responsive to signaling that the unlicensed frequency band 18 is deemed clear for the wireless device to transmit within, receiving a scheduling grant from the radio network node 12 that schedules uplink transmission to be performed by the wireless device within one or more portions of the unlicensed frequency band 18 and performing the uplink transmission according to the scheduling grant (Block 230). Alternatively or additionally, the method may comprise receiving from the radio network node 12 a request for the wireless device to signal whether the unlicensed frequency band 18 is deemed clear for the wireless device to transmit within. In this case, the determining and signaling may be performed in response to the request.

In the above-described embodiments, the radio network node 12 itself receives signaling 20 from the wireless devices 14 and accounts for that signaling 20 in how the radio network node 12 schedules uplink transmission within the unlicensed frequency band 18. In other embodiments, though, the wireless devices 14 alternatively or additionally signal whether the band 18 is deemed clear to other wireless devices 14, e.g., in a peer-to-peer fashion. The wireless devices 14 then determine for themselves within which portions (e.g., interlaces) of the unlicensed frequency band 18 they are to perform uplink transmission, e.g., according to preconfigured priorities of the devices 14 or services to which the uplink transmission relates.

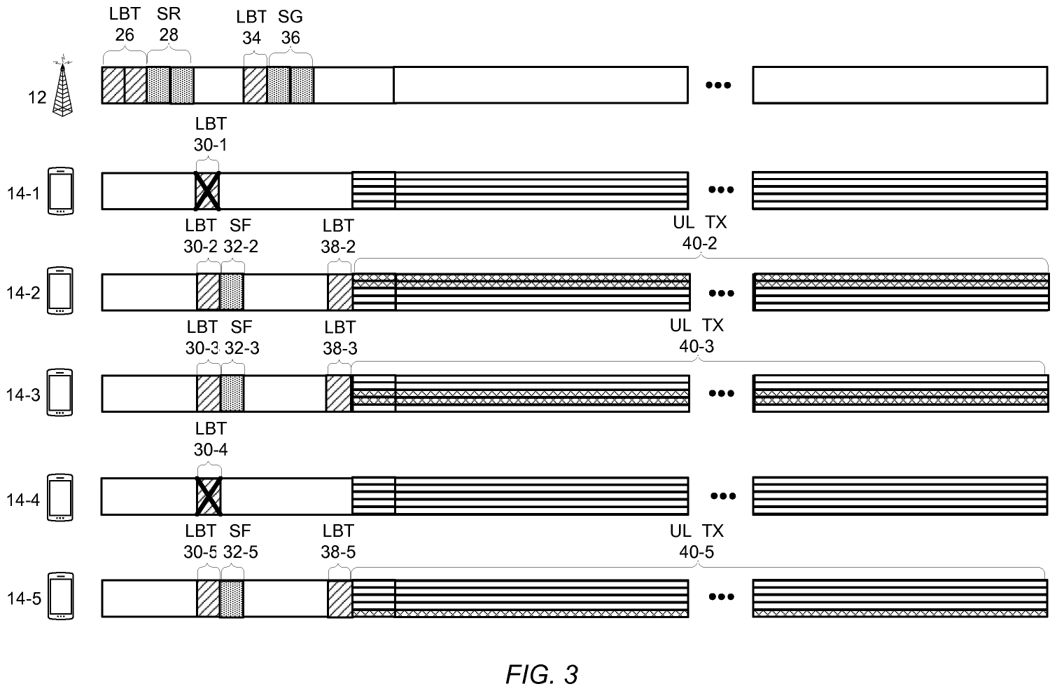

FIG. 5 illustrates an example of these embodiments in a similar context as that of FIG. 3, where the wireless devices 14 assumed to support full-duplex operation so as to transmit and receive simultaneously on the same carrier frequency. As shown, each wireless device 14-1 through 14-5 listens to SFs from other devices and then self-determines its transmitting interlaces (if any) based on the SFs' outcomes and its pre-configured priority.

In particular as shown in FIG. 5, after performing a long LBT 42 and seeing that the channel is free, the radio network node 12 sends a scheduling grant (SG) 44 to the wireless devices 14-1 through 14-5 that are candidates for performing uplink transmission in the unlicensed frequency band 18. Notice that the radio network node 12 sends this SG 44 without regard to any SF from the devices 14. Upon receiving the SG 44 from the radio network node 12, the devices 14-1 through 14-5 perform a short LBT 46-1 through 46-5 themselves. Devices 14-1 and 14-4 do not sense the band 18 as free and therefore do not transmit SF; instead they back their uplink transmission off. Devices 14-2, 14-3, and 14-5 by contrast do sense the band 18 as free and therefore transmit (e.g., broadcast) SF 48-2, 48-3, and 48-5. This SF 48 is transmitted to or intercepted by the other devices, e.g., in a peer-to-peer fashion. The devices 14-2, 14-3, and 14-5 that sense the band 18 as free then try to use the interlaces that will not be used by devices 14-1 and 14-4 that did not sense the band as free. As shown, for instance, device 14-2 performs uplink transmission 50-2 on interlaces 1 and 2, device 14-3 performs uplink transmission on interlaces 3 and 4, and device 14-5 performs uplink transmission on interlace 5. Each device in these embodiments may therefore have knowledge of which interlace(s) each of the other devices are nominally allocated to perform uplink transmission on, so that if any of the other devices are unavailable to perform that transmission the device can try to occupy it instead. In one embodiment, for instance, the devices 14 gain this knowledge from the SG 44, whereas in other embodiments the devices 14 gain this knowledge from the SF 48.

In some embodiments, in order to avoid multiple available devices 14 trying to occupy the same free interlaces simultaneously, each device is configured with a list of device priorities so that a device knows whether it is allowed to occupy a free interlace based on the SFs' information.

For example, assume the priority order in the example of FIG. 5 is from device 14-1 to device 14-5, with highest priority being device 14-1. Also assume that each device 14 is only allowed to occupy one extra interlace, i.e., a device 14 may transmit on at most 2 interlaces. Accordingly, device 14-2 with the highest priority amongst available devices 14-2, 14-3, and 14-5 is allowed to transmit on free interlace 1 that will not be occupied by device 14-1. Similarly, device 14-3 with the next highest priority amongst available devices 14-2, 14-3, and 14-5 is allowed to transmit on free interlace 4 that will not be occupied by device 14-4. Different configurations regarding priority class and maximum number of extra interlaces to occupy for each class can be used.

In some embodiments, the devices 14 are enabled to decode the SFs from other devices based on the devices being configured with the code sequence or interlace to be used for each devices' SFs. These code sequences or interlaces may for instance be associated with the device ID used in the scheduling grant 44.

Note that in the embodiments exemplified by FIG. 5, a sensing request may be explicitly included in the scheduling grant and the radio network node 12 does not perform re-scheduling after getting the SFs from the devices. Thus, the number times of DL/UL switching (which could require extra LBTs and delays every time the transmission direction is changed) is reduced as compared to other embodiments. This can compensate for the extra complexity added at the device side so that the devices can listen and decode the SFs from other devices.

As another aspect, due to the capability of the devices, the processing time at the devices to decode the SFs from other devices and/or to prepare the transport block according to the available interlaces could be fairly long. In this case, the devices may perform a short LBT again before they start their uplink transmissions.

As yet another aspect, the radio network node 12 does not use the information from the SFs for preparing its scheduling grant (SG 44). Thus, it can ignore (does not try to decode) the SFs from the devices in some embodiments. In other embodiments, though, the radio network node 12 indeed decodes the SFs so that it knows on which interlaces it should expect an uplink transmission from a certain device.

Consider now other embodiments that assume the devices 14 are only capable of half-duplex operation. In this case, the devices 14 require some switching time between receiving and transmitting and vice versa. The SFs may be shared among the devices 14 still, but the SF for each device may be transmitted using time division multiplexing (TDM). For example, following the scheduling grant sent by the radio network node 12, all devices 14 perform a short LBT. The order of sending the SF may be determined by the radio network node 12 and signaled in the scheduling grant.

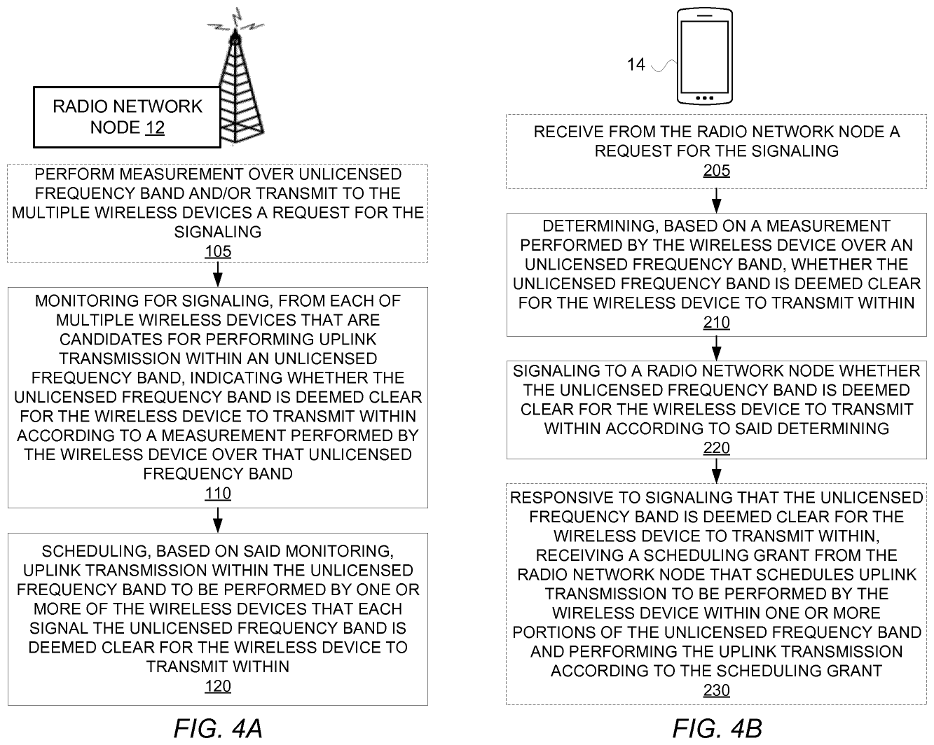

FIG. 6 illustrates an example. As shown, after receiving the SG 44, the device 14-1 through 14-5 take turns one after another performing a short LBT and transmitting SF if the short LBT succeeds. In the example, devices 14-1 and 14-4 fail their short LBTs 46-1 and 46-4 and refrain from transmitting the SF. By contrast, devices 14-2, 14-3, and 14-5 succeed with their short LBTs 46-2, 46-3, and 46-5 and transmit their SF 48-2, 48-3, and 48-5 in a TDM fashion. As shown, a gap is provided between two consecutive SFs from two different devices, to allow for the short LBT and the required switching time between transmit and receive mode and vice versa.

Note that although embodiments above have been described with respect to an unlicensed frequency band, embodiments herein are extendable to other types of shared frequency bands that condition transmission on sensing the frequency band as clear. This may be the cease even if the shared frequency band is not necessarily “unlicensed”. For example, embodiments herein are extendable to a licensed frequency band that is used for secondary licensed or unlicensed purposes.

Note further that embodiments herein may use any of one or more communication protocols known in the art or that may be developed, such as IEEE 802.xx, Code Division Multiple Access (CDMA), Wideband CDMA (WCDMA), Global System for Mobile telecommunications (GSM), Long Term Evolution (LTE), WiMax, New Radio (NR), or the like. Accordingly, although sometimes described herein in the context of 5G, the principles and concepts discussed herein are applicable to 4G systems and others.

Note that the radio network node 12 as described above may perform any of the processing herein by implementing any functional means or units. In one embodiment, for example, the radio network node 12 comprises respective circuits or circuitry configured to perform the steps shown in FIG. 4A. The circuits or circuitry in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more processors, carries out the techniques described herein.

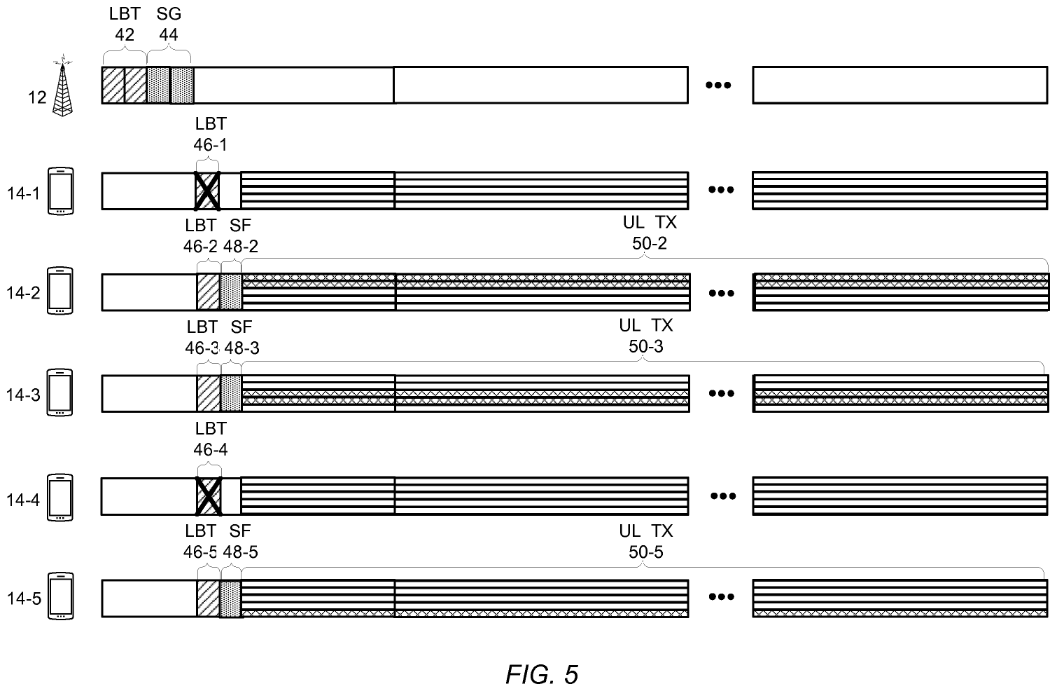

FIG. 7 illustrates radio network node 12 in accordance with one or more embodiments. As shown, the radio network node 12 includes processing circuitry 310 and communication circuitry 320. The radio network node 12 may also include power supply circuitry 340 configured to supply power to the radio network node 12. The communication circuitry 320 is configured to transmit and/or receive information to and/or from one or more other nodes, e.g., via any communication technology. The processing circuitry 310 is configured to perform processing described above, e.g., in FIG. 4A, such as by executing instructions stored in memory 330. The processing circuitry 310 in this regard may implement certain functional means, units, or modules.

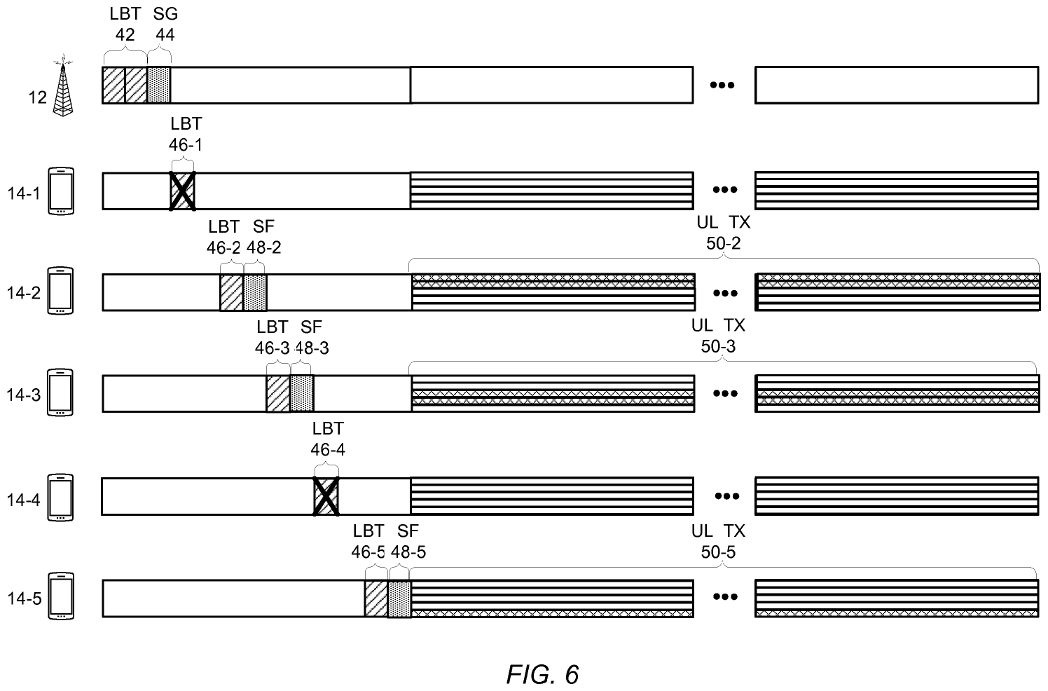

FIG. 8 illustrates a radio network node 12 in accordance with one or more other embodiments. As shown, the radio network node 12 implements various functional means, units, or modules, e.g., via the processing circuitry 310 in FIG. 7 and/or via software code. These functional means, units, or modules, e.g., for implementing the method in FIG. 4A, include for instance a monitoring unit 410 for monitoring for signaling 20, from each of multiple wireless devices 14 that are candidates for performing uplink transmission within the unlicensed frequency band 18, indicating whether the unlicensed frequency band 18 is deemed clear for the wireless device 14 to transmit within according to a measurement performed by the wireless device 14 over that unlicensed frequency band 18. Also included may be a scheduling unit 420 for scheduling, based on that monitoring, uplink transmission within the unlicensed frequency band 18 to be performed by one or more of the wireless devices 14A that each signal the unlicensed frequency band 18 is deemed clear for the wireless device to transmit within.

Also note that a wireless device 14 as described above may perform any of the processing herein by implementing any functional means or units. In one embodiment, for example, wireless device 14 comprises respective circuits or circuitry configured to perform the steps shown in FIG. 4B. The circuits or circuitry in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more processors, carries out the techniques described herein.

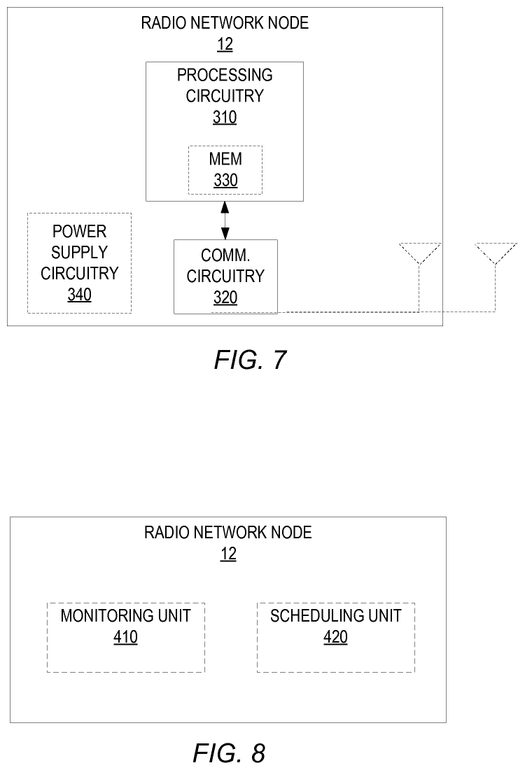

FIG. 9 illustrates wireless device 14 in accordance with one or more embodiments. As shown, the wireless device 14 includes processing circuitry 410 and communication circuitry 420. The wireless device 14 may also include power supply circuitry 440 configured to supply power to the wireless device 14. The communication circuitry 420 (e.g., radio circuitry) is configured to transmit and/or receive information to and/or from one or more other nodes, e.g., via any communication technology. Such may be performed via one or more antennas that are internal and/or external to the wireless device 14. The processing circuitry 410 is configured to perform processing described above, e.g., in FIG. 4B, such as by executing instructions stored in memory 430. The processing circuitry 410 in this regard may implement certain functional means, units, or modules.

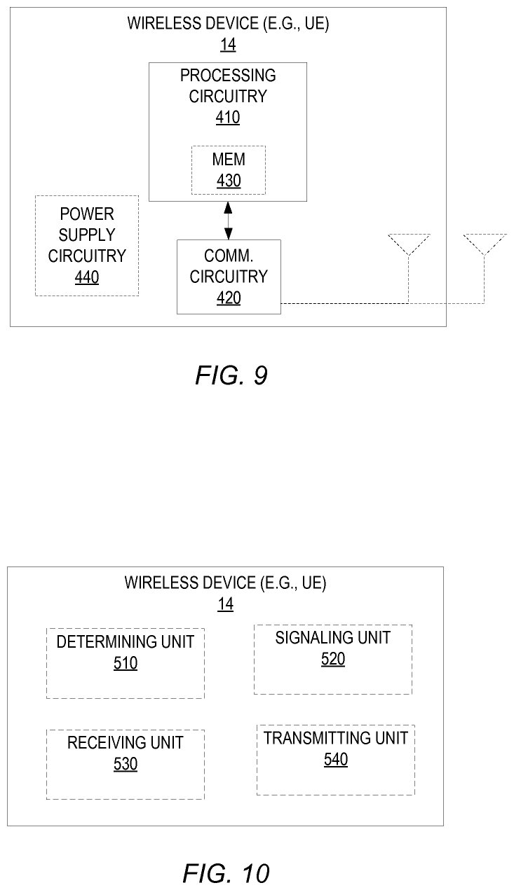

FIG. 10 illustrates wireless device 14 in accordance with one or more other embodiments. As shown, the wireless device 14 implements various functional means, units, or modules, e.g., via the processing circuitry 410 in FIG. 9 and/or via software code. These functional means, units, or modules, e.g., for implementing the method in FIG. 4B, include for instance a determining unit 510 for determining, based on a measurement performed by the wireless device 14 over the unlicensed frequency band 18, whether the unlicensed frequency band 18 is deemed clear for the wireless device to transmit within. Also included is a signaling unit 520 for signaling to a radio network node 12 whether the unlicensed frequency band 18 is deemed clear for the wireless device to transmit within according to that determining.

In some embodiments, a receiving unit 530 is included for responsive to signaling that the unlicensed frequency band 18 is deemed clear for the wireless device to transmit within, receiving a scheduling grant from the radio network node 12 that schedules uplink transmission to be performed by the wireless device within one or more portions of the unlicensed frequency band 18. A transmitting unit 540 may be included for performing the uplink transmission according to the scheduling grant.

Those skilled in the art will also appreciate that embodiments herein further include corresponding computer programs.

A computer program comprises instructions which, when executed on at least one processor of the radio network node 12, cause the radio network node 12 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a non-transitory computer readable (storage or recording) medium that has stored thereon instructions that, when executed by a processor of the radio network node 12, cause the radio network node 12 to perform as described above.

Also included herein is a computer program comprises instructions which, when executed on at least one processor of a wireless device 14, cause the wireless device 14 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a non-transitory computer readable (storage or recording) medium that has stored thereon instructions that, when executed by a processor of a wireless device 14, cause the wireless device 14 to perform as described above.

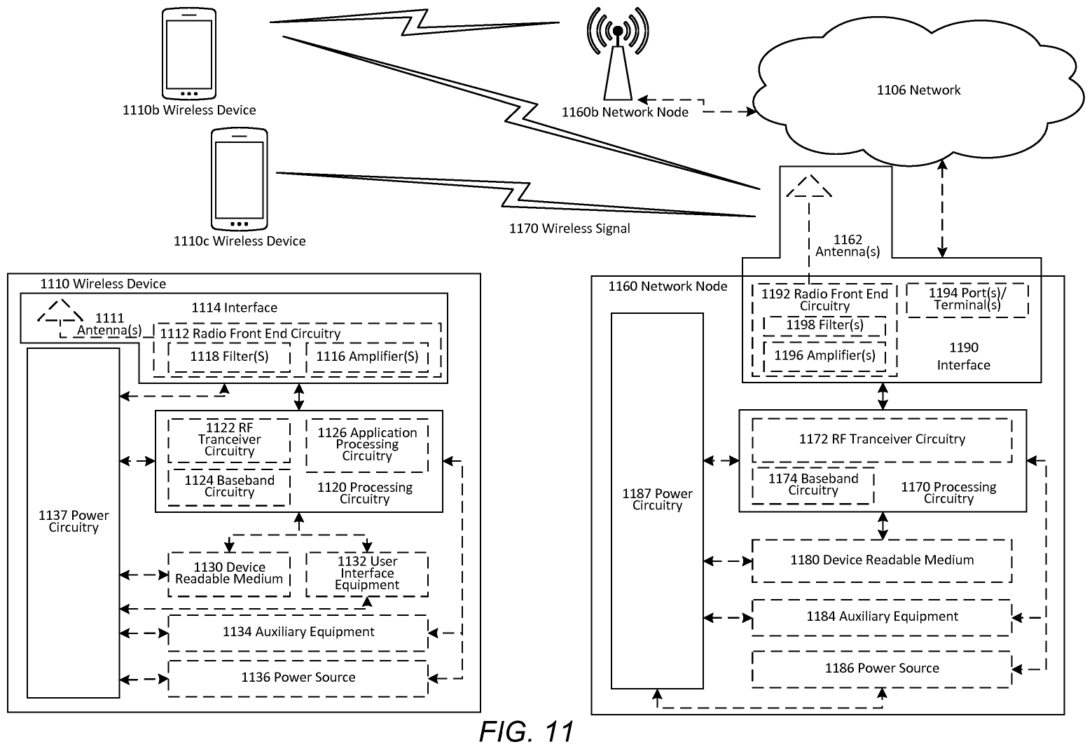

Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 11, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 11 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 11 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

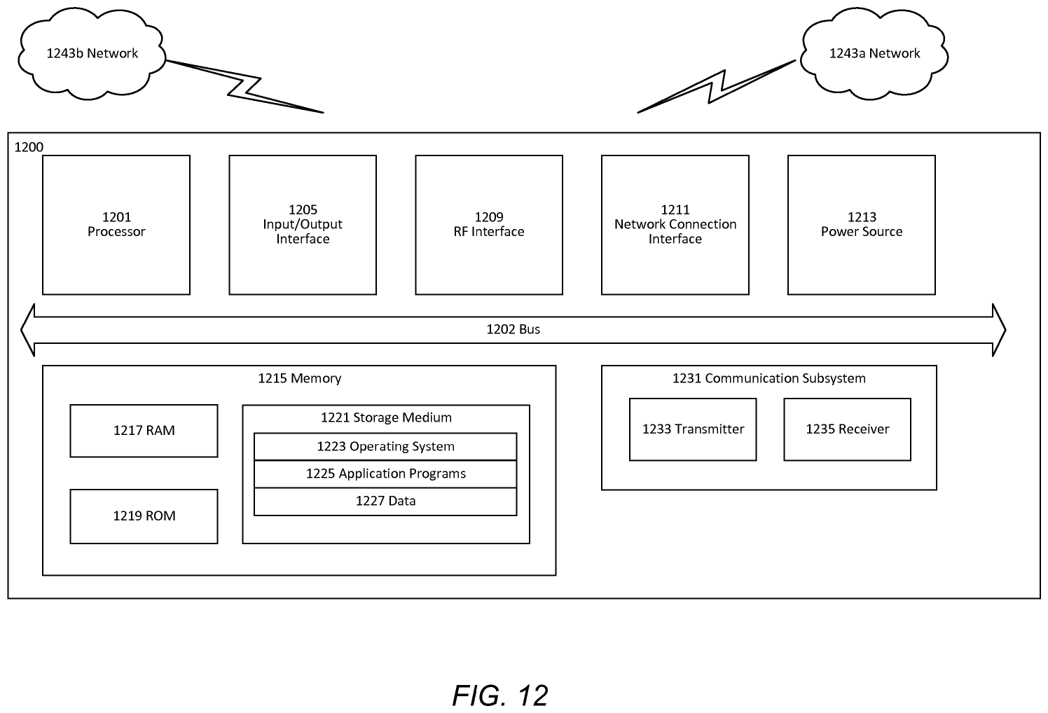

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 12, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 12, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

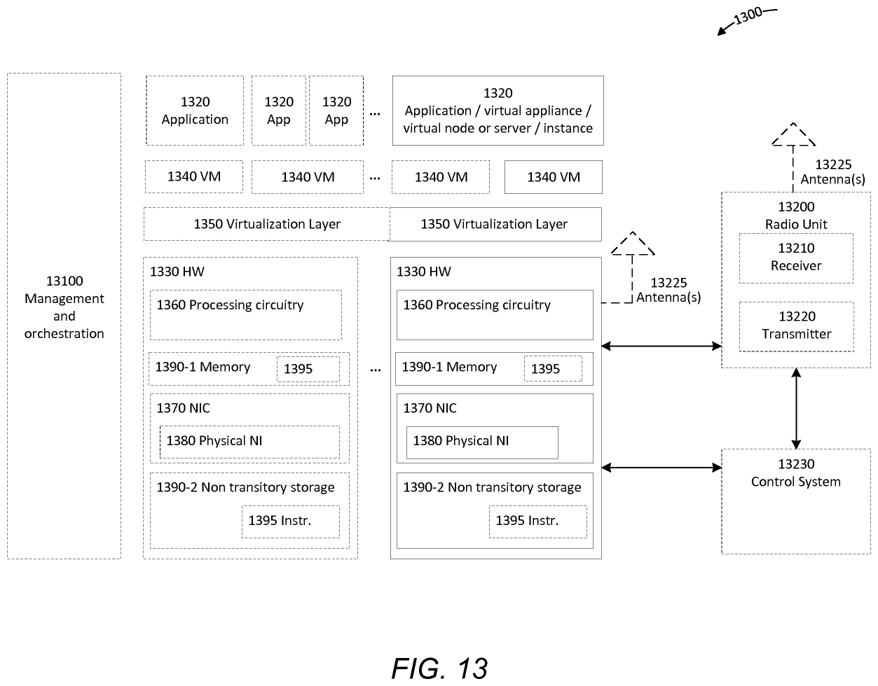

FIG. 13 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

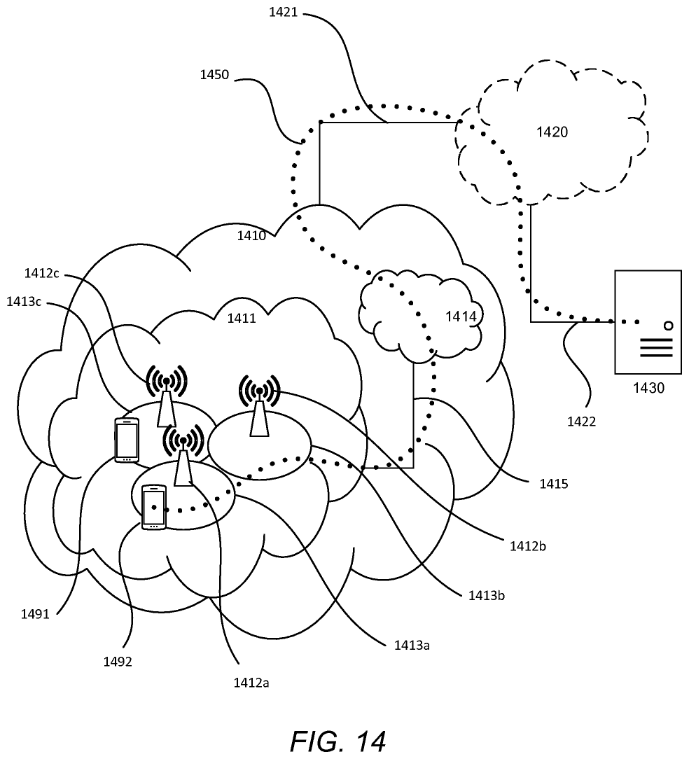

FIG. 14 illustrates a telecommunication network connected via an intermediate network to a host computer in accordance with some embodiments. In particular, with reference to FIG. 14, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 14 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

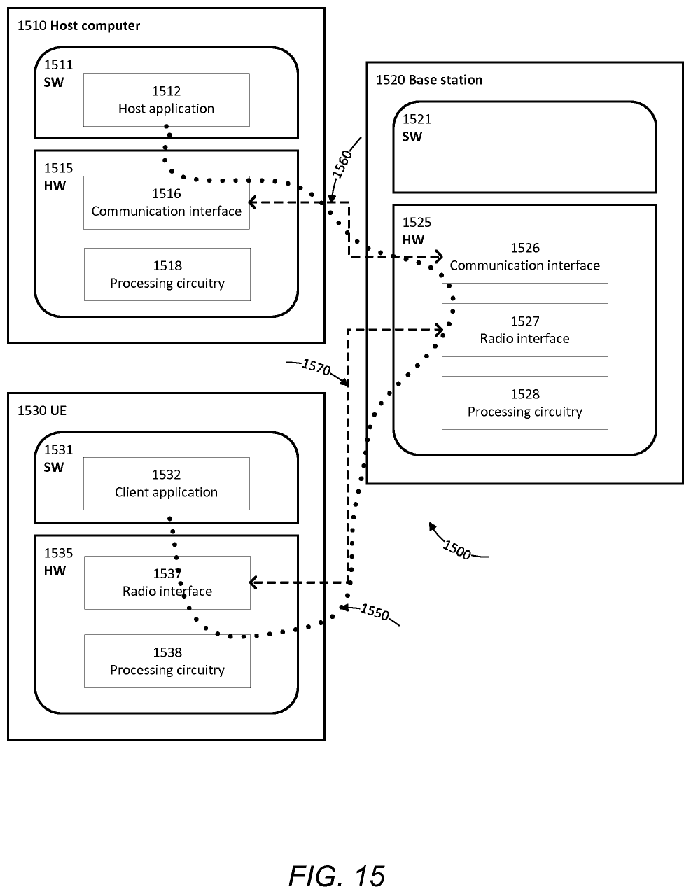

Example implementations, in accordance with an embodiment, of the UE, base station and host computer discussed in the preceding paragraphs will now be described with reference to FIG. 15. FIG. 15 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 15) served by base station 1520. Communication interface 1526 may be configured to facilitate connection 1560 to host computer 1510. Connection 1560 may be direct or it may pass through a core network (not shown in FIG. 15) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer 1430, one of base stations 1412a, 1412b, 1412c and one of UEs 1491, 1492 of FIG. 14, respectively. This is to say, the inner workings of these entities may be as shown in FIG. 15 and independently, the surrounding network topology may be that of FIG. 14.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the data latency and power consumption and thereby provide benefits such as reduced user waiting time, better responsiveness, and reduced environmental footprint.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510′s measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

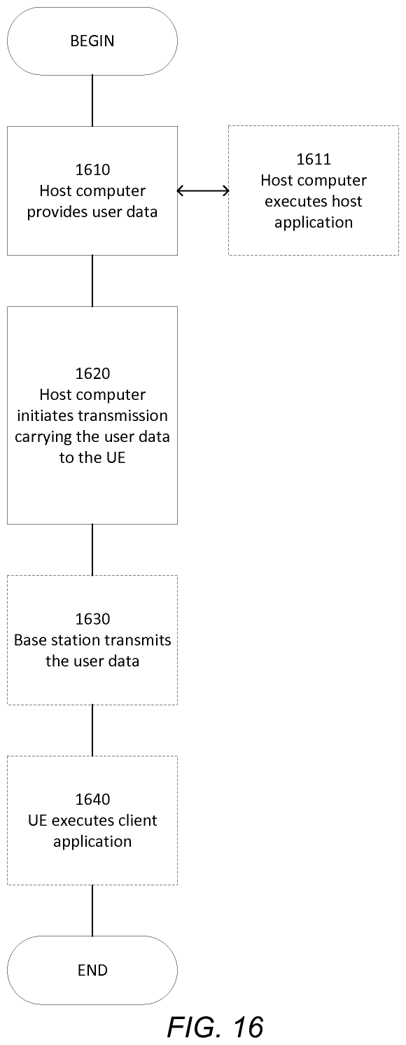

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

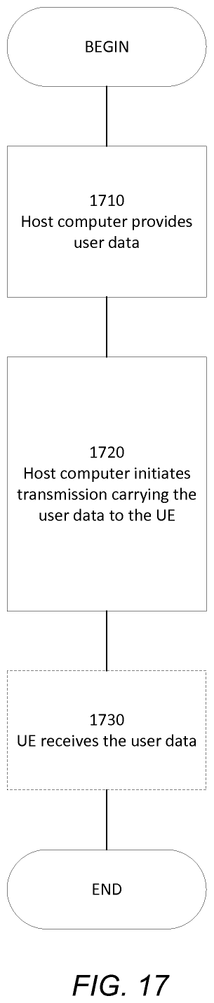

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

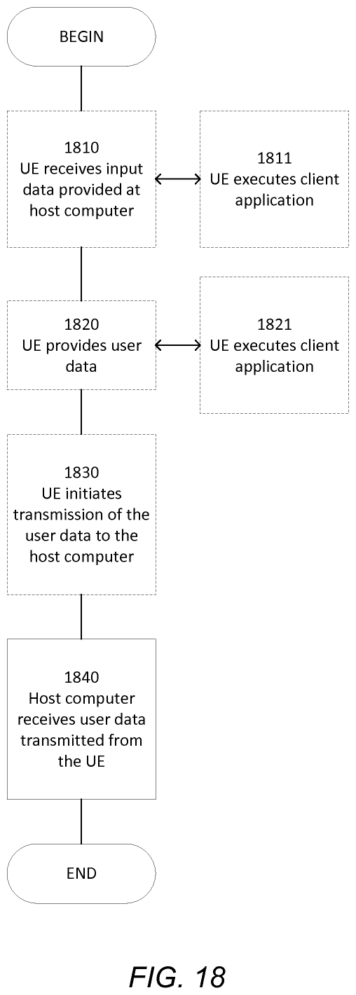

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

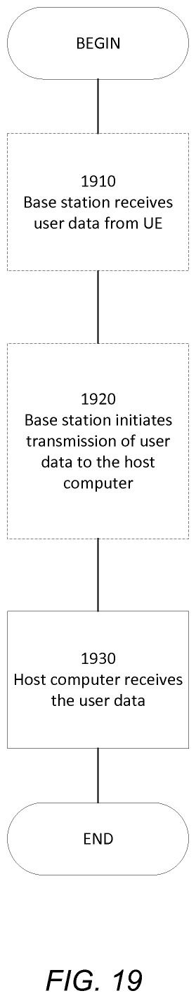

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

1.-29. (canceled)

30. A radio network node configured for use in a wireless communication system, the radio network node comprising:
communication circuitry; and
processing circuitry configured to:
monitor for signaling, from each of multiple wireless devices that are candidates for performing uplink transmission within an unlicensed frequency band, indicating whether the unlicensed frequency band is deemed clear for the wireless device to transmit within according to a measurement performed by the wireless device over that unlicensed frequency band; and
schedule, based on said monitoring, uplink transmission within the unlicensed frequency band to be performed by one or more of the wireless devices that each signal the unlicensed frequency band is deemed clear for the wireless device to transmit within.

31. The radio network node of claim 30, schedule uplink transmission to be performed by the one or more wireless devices collectively across all uplink portions of the unlicensed frequency band.

32. The radio network node of claim 30, wherein the processing circuitry is configured to schedule uplink transmission to be performed by each of the one or more wireless devices within different respective uplink portions of the unlicensed frequency band.

33. The radio network node of claim 32, wherein the different respective uplink portions of the unlicensed frequency band are different respective frequency interlaces of the unlicensed frequency band.

34. The radio network node of claim 33, wherein the processing circuitry is configured to schedule uplink transmission to be performed by at least one of the one or more wireless devices within multiple frequency interlaces of the unlicensed frequency band.

35. The radio network node of claim 30, wherein the processing circuitry is configured to schedule uplink transmission to be performed within the unlicensed frequency band during a transmission time interval by one or more of the wireless devices that each signal the unlicensed frequency band is deemed clear for the wireless device to transmit within and refrain from scheduling uplink transmission to be performed within the unlicensed frequency band during the transmission time interval by one or more of the wireless devices that each signal the unlicensed frequency band is not deemed clear for the wireless device to transmit within.

36. The radio network node of claim 30, wherein the processing circuitry is further configured to:
transmit to a first wireless device of the multiple wireless devices a first scheduling grant that schedules uplink transmission to be performed by the first wireless device within a first portion of the unlicensed frequency band and transmit to a second wireless device of the multiple wireless devices a second scheduling grant that schedules uplink transmission to be performed by the second wireless device within a second portion of the unlicensed frequency band; and
determine, after transmitting the first and second scheduling grants and based on monitoring for the signaling, that the unlicensed frequency band is not deemed clear for the first wireless device to transmit within and is deemed clear for the second wireless device to transmit within;
wherein the processing circuitry is configured to, based on determining that the unlicensed frequency band is not deemed clear for the first wireless device to transmit within and is deemed clear for the second wireless device to transmit within, transmit to the second wireless device an additional scheduling grant that schedules uplink transmission to be performed by the second wireless device within the first portion of the unlicensed frequency band.

37. The radio network node of claim 30, wherein the processing circuitry is further configured to:
transmit to a first wireless device of the multiple wireless devices information indicating a nominal assignment of the first wireless device to perform uplink transmission within a first portion of the unlicensed frequency band and transmit to a second wireless device of the multiple wireless devices information indicating a nominal assignment of the second wireless device to perform uplink transmission within a second portion of the unlicensed frequency band; and
determine, after transmitting the information to the first and second wireless devices and based on monitoring for the signaling, that the unlicensed frequency band is not deemed clear for the first wireless device to transmit within and is deemed clear for the second wireless device to transmit within;
wherein the processing circuitry is configured to, based on determining that the unlicensed frequency band is not deemed clear for the first wireless device to transmit within and is deemed clear for the second wireless device to transmit within, transmit to the second wireless device one or more scheduling grants that schedule uplink transmission to be performed by the second wireless device within both the first and second portions of the unlicensed frequency band.

38. The radio network node of claim 30, wherein the processing circuitry is further configured to transmit, to each of the multiple wireless devices, a request for the wireless device to signal whether the unlicensed frequency band is deemed clear for the wireless device to transmit within.

39. The radio network node of claim 30, wherein the processing circuitry is configured to transmit a scheduling grant, indicating scheduling of the uplink transmission to be performed by the one or more of the wireless devices, to a wireless device that signals the unlicensed frequency band is deemed clear for the wireless device to transmit within, wherein the scheduling grant indicates a time at which the scheduled uplink transmission is to be started by the wireless device and indicates whether a sounding reference signal is to be transmitted after the scheduling grant but before the scheduled uplink transmission.

40. A wireless device configured for use in a wireless communication system, the wireless device comprising:
communication circuitry; and
processing circuitry configured to:
determine, based on a measurement performed by the wireless device over an unlicensed frequency band, whether the unlicensed frequency band is deemed clear for the wireless device to transmit within;
signal to a radio network node whether the unlicensed frequency band is deemed clear for the wireless device to transmit within according to said determining; and
responsive to signaling that the unlicensed frequency band is deemed clear for the wireless device to transmit within, receive a scheduling grant from the radio network node that schedules uplink transmission to be performed by the wireless device within one or more portions of the unlicensed frequency band and perform the uplink transmission according to the scheduling grant.

41. The wireless device of claim 40, wherein the processing circuitry is further configured to, before signaling to the radio network node whether the unlicensed frequency band is deemed clear for the wireless device to transmit, receive from the radio network node another scheduling grant that schedules uplink transmission to be performed by the wireless device within a nominal portion of the unlicensed frequency band, such that the scheduling grant received responsive to said signaling schedules uplink transmission to be performed by the wireless device within one or more additional portions of the unlicensed frequency band.

42. The wireless device of claim 40, wherein the processing circuitry is further configured to, before signaling to the radio network node whether the unlicensed frequency band is deemed clear for the wireless device to transmit, receive from the radio network node information indicating a nominal assignment of the wireless device to perform uplink transmission within a nominal portion of the unlicensed frequency band, wherein the scheduling grant received responsive to said signaling schedules uplink transmission to be performed by the wireless device within the nominal portion as well as one or more additional portions of the unlicensed frequency band.

43. The wireless device of claim 41, wherein the processing circuitry is further configured to, before receiving the scheduling grant, prepare for uplink transmission within the nominal portion, and, after receiving the scheduling grant, perform uplink transmission within the nominal portion before performing uplink transmission within the one or more additional portions.

44. The wireless device of claim 40, wherein the processing circuitry is further configured to receive from the radio network node a request for the wireless device to signal whether the unlicensed frequency band is deemed clear for the wireless device to transmit within, wherein the processing circuitry is configured to determine whether the unlicensed frequency band is deemed clear for the wireless device to transmit within, and to signal to the radio network node whether the unlicensed frequency band is deemed clear for the wireless device to transmit within, in response to the request.

45. The wireless device of claim 40, wherein the processing circuitry is further configured to, after receiving the scheduling grant but before performing the scheduled uplink transmission, transmit a sounding reference signal.

46. The wireless device of claim 45, wherein the scheduling grant indicates a time at which uplink transmission is to be started by the wireless device and indicates whether a sounding reference signal is to be transmitted after the scheduling grant but before the uplink transmission.

47. The wireless device of claim 40, wherein the one or more portions of the unlicensed frequency band comprise one or more frequency interlaces of the unlicensed frequency band.

48. A method performed by a radio network node configured for use in a wireless communication system, the method comprising:
monitoring for signaling, from each of multiple wireless devices that are candidates for performing uplink transmission within an unlicensed frequency band, indicating whether the unlicensed frequency band is deemed clear for the wireless device to transmit within according to a measurement performed by the wireless device over that unlicensed frequency band; and
scheduling, based on said monitoring, uplink transmission within the unlicensed frequency band to be performed by one or more of the wireless devices that each signal the unlicensed frequency band is deemed clear for the wireless device to transmit within.

49. A method performed by a wireless device configured for use in a wireless communication system, the method comprising:
determining, based on a measurement performed by the wireless device over an unlicensed frequency band, whether the unlicensed frequency band is deemed clear for the wireless device to transmit within;
signaling to a radio network node whether the unlicensed frequency band is deemed clear for the wireless device to transmit within according to said determining;
responsive to signaling that the unlicensed frequency band is deemed clear for the wireless device to transmit within, receiving a scheduling grant from the radio network node that schedules uplink transmission to be performed by the wireless device within one or more portions of the unlicensed frequency band and performing the uplink transmission according to the scheduling grant.
